(19) United States
(12) Patent Application Publication
(10) Pub. No.: US 2009/0049137 A1
(43) Pub. Date: Feb. 19, 2009

(54) REFERENCING RELATIVE ROLE SUFFIXES IN A COLLABORATIVE COMPUTING ENVIRONMENT

(75) Inventors: Michael Muller, Medford, MA (US); Andrew L. Schirmer, Andover, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/839,857

(22) Filed: Aug. 16, 2007

(51) Int. Cl. G06F 15/16

(52) U.S. Cl. 709/206; 709/225

(57) ABSTRACT

Embodiments of the present invention address deficiencies of the art in respect to referencing organizational roles in a collaborative computing environment and provide a novel and non-obvious method, system and computer program product for referencing relative role suffixes in a collaborative computing environment. In one embodiment of the invention, a method for referencing relative role suffixes in a collaborative computing environment can include receiving as input to a collaborative tool in the collaborative computing environment, a relative reference to a member of the collaborative computing environment and decomposing the relative reference into a prefix and a suffix. The method further can include determining a member specified by the prefix and a role specified by the suffix and transforming the role to a member of the collaborative computing environment relative to the member specified by the prefix. Finally, the method can include returning the transformed member to the collaborative tool.

### BACKGROUND OF THE INVENTION

1. Field of the Invention

The present invention relates to the field of collaborative computing and more particularly to the field of role processing in a collaborative computing environment.

2. Description of the Related Art

The rapid development of the Internet has led to advanced modes of communication and collaboration. Using the Internet as a backbone, individuals worldwide can converge in cyberspace to share ideas, documents and images in a manner not previously possible through conventional telephony and video conferencing. To facilitate collaboration over the Internet, a substantial collection of technologies and protocols have been assembled to effectively deliver audio, video and data over the single data communications medium of the Internet. These technologies include document libraries, instant messaging, chat rooms, and application sharing.

Conventional collaborative computing includes combinations of collaborative technologies in order to provide a means for members of a collaborative community to pool their strengths and experiences to achieve a common goal. For instance, a common goal can include an educational objective, the completion of a software development project or even the creation and use of a system to manage human resources. A collaborative computing community generally can be defined by (1) a particular context, i.e. the objective of the environment, (2) membership, i.e., the participants in the environment, (3) a set of roles for the members, and (4) resources and tools which can be accessed by the membership in furtherance of the objective of the environment. A role is a classification applied to a subset of the people in the environment that acts as a placeholder for the subset of the people in dictating access to the resources and tools within the environment as well as define the behavior of the community members.

Collaborative communities can be multi-hierarchical. That is different members of a community can fulfill multiple roles at different tiers of a hierarchy. Thus, in a collaborative community, members can be structured differently within the same community depending upon a particular role. For instance, in an educational community, members of the community can be hierarchically classified according teacher and student, as well as by social security number, as well as by gender, as well as by extracurricular affiliation. Notably, in some communities, different members can fulfill multiple roles, including supervisors, administrative assistants, human resources professionals, students, teachers, players, coaches, owners and operators.

Members of a collaborative computing community refer to one another expressly by identity. A common mode of reference to a member includes an e-mail address for the member, such as “specific_person@community.com” or “Specific Person/Specific Office/Community” as the case may be. While making specific reference to a member has been the long-standing principle of operation in a collaborative community, there are occasions when one may prefer to reference a role within an organization rather than a specific member. For instance, it may be desirable to reference a supervisor or administrator rather than the specific member filling the role of supervisor or administrator. In a community of many members, referencing an organizational role rather than an individual can be of paramount importance given the likelihood that the identity of a specific member filling a particular role may not be known off hand.

### BRIEF SUMMARY OF THE INVENTION

Embodiments of the present invention address deficiencies of the art in respect to referencing organizational roles in a collaborative computing environment and provide a novel and non-obvious method, system and computer program product for referencing relative role suffixes in a collaborative computing environment. In one embodiment of the invention, a method for referencing relative role suffixes in a collaborative computing environment can include receiving as input to a collaborative tool such as an e-mail message or instant message in the collaborative computing environment, a relative reference to a member of the collaborative computing environment and decomposing the relative reference into a prefix and a suffix. The method further can include determining a member specified by the prefix and a role specified by the suffix and transforming the role to a member of the collaborative computing environment relative to the member specified by the prefix. Finally, the method can include returning the transformed member to the collaborative tool.

In one aspect of the embodiment, the relative reference to a member of the collaborative computing environment can include a textually specified relative reference to a member of the collaborative computing environment. In another aspect of the embodiment, the relative reference to a member of the collaborative computing environment can include a combination of a textually specified member for the prefix and a selected valid role for the suffix selected from a generative list of valid roles for the textually specified member for the prefix. In the former circumstance, determining a member specified by the prefix and a role specified by the suffix can include determining a member specified by the prefix, locating a synonymous role to the role specified by the suffix, and determining a member specified by the prefix and the synonymous role.

In another embodiment of the invention, a collaborative computing data processing system can be configured for referencing relative role suffixes. The system can include a collaborative computing environment executing in a host computing platform, a relative role suffix table comprising associations between different members of the collaborative computing environment and related role, and a relative role suffix processor coupled to the host computing platform. The processor can include program code enabled to receive as input to a collaborative tool in the collaborative computing environment, a relative reference to a member of the collaborative computing environment, to decompose the relative reference into a prefix and a suffix, to access the relative role suffix table to determine a member specified by the prefix and a role specified by the suffix, to transform the role to a member of the collaborative computing environment relative to the member specified by the prefix, and to return the transformed member to the collaborative tool.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a collaborative computing environment configured for referencing relative role suffixes;

FIG. 2 is a schematic illustration of a collaborative computing system configured for referencing relative role suffixes; and,

FIG. 3 is a flow illustrating a process for referencing relative role suffixes in a collaborative computing environment.

### DETAILED DESCRIPTION OF THE INVENTION

Embodiments of the present invention provide a method, system and computer program product for referencing relative role suffixes in a collaborative computing environment. In accordance with an embodiment of the present invention, a relative reference to a member of a collaborative computing environment can be provided for resolution into an express reference to a member of the collaborative computing environment. The relative reference can include a prefix identifying a specific member or role in the collaborative community and a suffix identifying a role relative to the prefix. Thereafter, the express reference can be computed as the identity of the member fulfilling the role of the suffix relative to the member identified by the prefix. In consequence, members of the community can reference other members, not directly by name, but indirectly by role relative to another member.

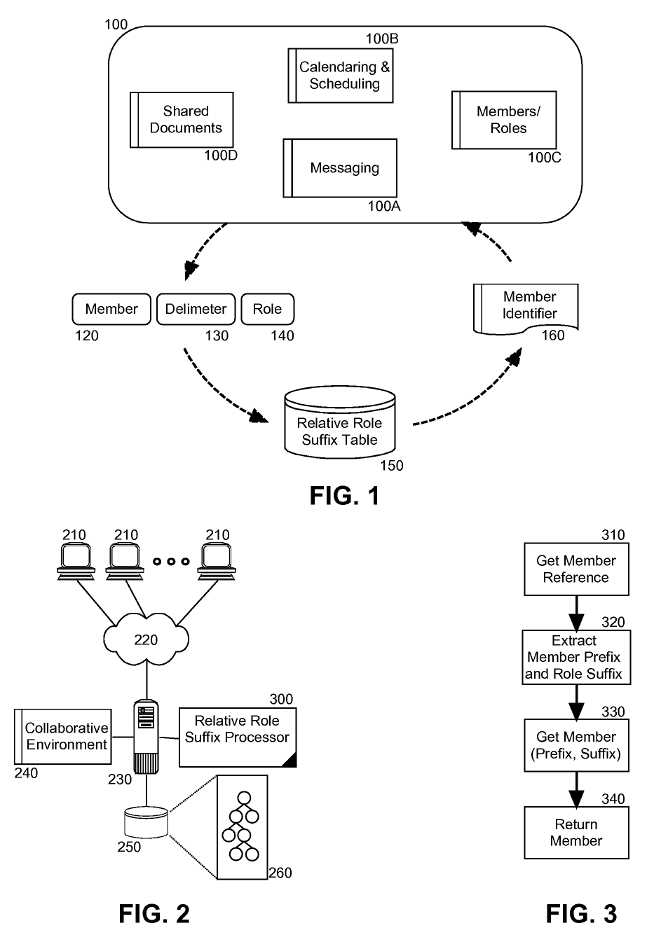

In further illustration, FIG. 1 is a pictorial illustration of a collaborative computing environment configured for referencing relative role suffixes. The collaborative computing environment 100 can include one or more integrated collaborative computing components, such as messaging components 100A, calendaring and scheduling 100B, membership and role management 100C and a shared document library 100N. Notably, the membership and role management 100C can be configured to manage the membership of the collaborative computing environment 100 so as to account not only for individual members, but also roles defined for the collaborative computing environment 100 and associations between the members and the roles.

In accordance with an embodiment of the invention, a relative reference to a member can be defined by a prefix 120 and a suffix 140 delimited by delimiter 130. The prefix 120 can refer to a member or a role in the collaborative computing environment, whereas the suffix 140 can refer to a role in the collaborative computing environment. A table of relative role suffixes 150 can be queried to resolve a member identifier 160 from the prefix 120 and suffix 140. Specifically, the prefix 120 can be resolved to an intermediate specific member of the collaborative computing environment. Thereafter, the suffix can be resolved to a final specific member of the collaborative computing environment by determining the role of the suffix 140 with respect to the intermediate specific member.

For example, the following divisional organizational chart can be traversed through the relative role suffix processing of the present invention:

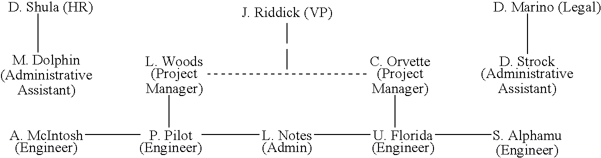

In the illustrated divisional organizational chart, D. Shula manages the human resources role for the division headed by J. Riddick, the vice-president and enjoys the support of M. Dolphin as an administrative assistant. Likewise, D. Marino manages the legal role for the division and enjoys the support of D. Strock as an administrative assistant. Both L. Woods and C. Orvette are project managers each of whom report separately to J. Riddick and each of whom share the support of L. Notes, an administrative assistant. Finally, A. McIntosh and P. Pilot are engineers who report to L. Woods, while U. Florida and S. Alphamu are engineers reporting to S. Alphamu.

The following relative role suffixes resolve to the different individuals in the exemplary divisional organizational chart:

| | | |
|---|---|---|
| A. McIntosh.self | ---> | A. McIntosh |
| A. McIntosh.supervisor | ---> | L. Woods |
| A. McIntosh.hr | ---> | D. Shula |
| A. McIntosh.legal | ---> | D. Marino |
| A. McIntosh.vp | ---> | J. Riddick |
| C. Orvette.self | ---> | C. Orvette |
| C. Orvette.supervisor | ---> | J. Riddick |
| C. Orvette.hr | ---> | D. Shula |
| C. Orvette.legal | ---> | D. Marino |
| C. Orvette.vp | ---> | J. Riddick |
| C. Orvette.admin | ---> | L. Notes |
| hr.admin | ---> | M. Dolphin |
| legal.admin | ---> | D. Strock |

Thus, a member of the collaborative computing community for the exemplary division need not maintain the organizational chart, but can resolve member identities merely by stating the identity of a member and a relative role suffix, or alternatively by stating a role prefix and a relative role suffix. Advantageously, since members fulfilling roles change often in an organization, the specification of a role can dynamically resolve to a correct member identity without requiring members to maintain accurate, up-to-date organizational charts. It will be noted by the skilled artisan, however, that other forms of stating a role prefix and relative role suffix can be provided. For example, specifying a principal and role can suffice such as Suffix(Prefix). An example would include Paralegal(Greenberg)

The relative role suffix processing can be performed in a collaborative computing system. In illustration, FIG. 2 is a schematic illustration of a collaborative computing system configured for referencing relative role suffixes. As shown in FIG. 2, the collaborative computing system can include a host computing platform 230 communicatively coupled to one or more collaborative clients 210 over computer communications network 220. The host computing platform 230 can support the operation of a collaborative environment 240 including e-mail, instant messaging, instant meeting, shared document libraries, and calendaring and scheduling functionality, by way of example.

A relative role suffix table 250 can be coupled to the host computing platform 230 and can model an organizational chart 260 for an organization supported by the collaborative computing environment 240. Notably, relative role suffix processor 300 further can be coupled to the host computing platform 230 and can be configured to access the relative role suffix table 250. The relative role suffix processor 300 can include program code enabled to resolve a relative reference to a member in the collaborative computing environment 240. In this regard, the relative reference can include a prefix identifying a specific member or role and a suffix identifying a role relative to the prefix in the form of [prefix] [delimiter] [suffix].

Thereafter, an express reference to a member in the collaborative computing environment 240 can be computed as the identity of the member fulfilling the role of the suffix relative to the member identified by the prefix as indicated by the relative role suffix table 250. In consequence, members in the collaborative computing environment 240 can reference other members, not directly by name, but indirectly by role relative to another member. In further illustration of the operation of the relative role suffix process 300, FIG. 3 is a flow illustrating a process for referencing relative role suffixes in a collaborative computing environment.

Beginning in block 310, a relative reference to a member of the collaborative computing community can be received. For example, the relative reference can be provided directly as text into a collaborative computing tool in the collaborative computing community, or the relative reference can be constructed through a user interface providing a set of choices as to both the prefix and the suffix of the relative reference. Alternatively, a user interface of possible suffixes can be provided in response to a particular prefix in order to limit a range of valid roles for a specific member associated with a specified prefix.

Optionally, multiple different synonymous names for the same role can be processed equivalently at the time of the receipt of the relative reference such as “human resources” and “hr” or “admin” and “administrative assistant” by way of example. In block 320, the relative reference can be decomposed into the prefix and the suffix. To the extent that the prefix also is a role, the role can be reduced to a member identity. Thereafter, in block 330, a member identity can be resolved for the role relative to the member associated with the prefix. Subsequently, in block 340 the resolved member can be returned to the collaborative tool for further processing.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for referencing relative role suffixes in a collaborative computing environment, the method comprising:
receiving as input to a collaborative tool in the collaborative computing environment, a relative reference to a member of the collaborative computing environment;
decomposing the relative reference into a prefix and a suffix;
determining a member specified by the prefix and a role specified by the suffix;
transforming the role to a member of the collaborative computing environment relative to the member specified by the prefix; and,
returning the transformed member to the collaborative tool.

2. The method of claim 1, wherein receiving as input to a collaborative tool in the collaborative computing environment, a relative reference to a member of the collaborative computing environment, comprises receiving as input to a collaborative tool in the collaborative computing environment, a textually specified relative reference to a member of the collaborative computing environment.

3. The method of claim 1, wherein receiving as input to a collaborative tool in the collaborative computing environment, a relative reference to a member of the collaborative computing environment, comprises:
receiving as input to a collaborative tool in the collaborative computing environment, a textually specified member;
generating a list of valid roles for the textually specified member; and,
selecting one of the valid roles for combination with the textually specified member; and,
combining the textually specified member with a delimiter and the selected one of the valid roles to produce the relative reference to a member of the collaborative computing environment.

4. The method of claim 1, wherein receiving as input to a collaborative tool in the collaborative computing environment, a relative reference to a member of the collaborative computing environment, comprises receiving as input to either an e-mail message or an instant message in the collaborative computing environment, a relative reference to a member of the collaborative computing environment;

5. The method of claim 1, wherein determining a member specified by the prefix and a role specified by the suffix, comprises:
determining a member specified by the prefix;
locating a synonymous role to the role specified by the suffix; and,
determining a member specified by the prefix and the synonymous role.

6. The method of claim 1, wherein determining a member specified by the prefix and a role specified by the suffix comprises determining a member specified by a role specified by the prefix and a role specified by the suffix.

7. A collaborative computing data processing system configured for referencing relative role suffixes, the system comprising:
a collaborative computing environment executing in a host computing platform;
a relative role suffix table comprising associations between different members of the collaborative computing environment and related roles; and, relative role suffix processor coupled to the host computing platform, the processor comprising program code enabled to receive as input to a collaborative tool in the collaborative computing environment, a relative reference to a member of the collaborative computing environment, to decompose the relative reference into a prefix and a suffix, to access the relative role suffix table to determine a member specified by the prefix and a role specified by the suffix, to transform the role to a member of the collaborative computing environment relative to the member specified by the prefix, and to return the transformed member to the collaborative tool.

8. A computer program product comprising a computer usable medium embodying computer usable program code for referencing relative role suffixes in a collaborative computing environment, the computer program product comprising:
computer usable program code for receiving as input to a collaborative tool in the collaborative computing environment, a relative reference to a member of the collaborative computing environment;
computer usable program code for decomposing the relative reference into a prefix and a suffix;
computer usable program code for determining a member specified by the prefix and a role specified by the suffix;
computer usable program code for transforming the role to a member of the collaborative computing environment relative to the member specified by the prefix; and,
computer usable program code for returning the transformed member to the collaborative tool.

9. The computer program product of claim 8, wherein the computer usable program code for receiving as input to a collaborative tool in the collaborative computing environment, a relative reference to a member of the collaborative computing environment, comprises computer usable program code for receiving as input to a collaborative tool in the collaborative computing environment, a textually specified relative reference to a member of the collaborative computing environment.

10. The computer program product of claim 8, wherein the computer usable program code for receiving as input to a collaborative tool in the collaborative computing environment, a relative reference to a member of the collaborative computing environment, comprises:
computer usable program code for receiving as input to a collaborative tool in the collaborative computing environment, a textually specified member;
computer usable program code for generating a list of valid roles for the textually specified member; and,
computer usable program code for selecting one of the valid roles for combination with the textually specified member; and,
computer usable program code for combining the textually specified member with a delimiter and the selected one of the valid roles to produce the relative reference to a member of the collaborative computing environment.

11. The computer program product of claim 8, wherein the computer usable program code for receiving as input to a collaborative tool in the collaborative computing environment, a relative reference to a member of the collaborative computing environment, comprises computer usable program code for receiving as input to either an e-mail message or an instant message in the collaborative computing environment, a relative reference to a member of the collaborative computing environment;

12. The computer program product of claim 8, wherein the computer usable program code for determining a member specified by the prefix and a role specified by the suffix, comprises:
computer usable program code for determining a member specified by the prefix;
computer usable program code for locating a synonymous role to the role specified by the suffix; and,
computer usable program code for determining a member specified by the prefix and the synonymous role.

13. The computer program product of claim 8, wherein the computer usable program code for determining a member specified by the prefix and a role specified by the suffix comprises computer usable program code for determining a member specified by a role specified by the prefix and a role specified by the suffix.
